(19) United States
(12) Patent Application Publication
(10) Pub. No.: US 2007/0083628 A1
(43) Pub. Date: Apr. 12, 2007

(54) Automated, transparent and secure system and method for remotely managing network elements

(76) Inventor: Mark Henrik Sandstrom, Calgary (CA)

Correspondence Address: Mark Henrik Sandstrom, #2604, 700-9th Street SW, Calgary, AB, T2P 2B5, CA

(21) Appl. No.: 11/245,974

(22) Filed: Oct. 11, 2005

(51) Int. Cl. G06F 15/173

(52) U.S. Cl. 709/223

(57) ABSTRACT

A network management system for securely managing network elements (NEs) over arbitrary multi-operator networks, via managing copies of NE configuration files on general purpose computers on a network operations center (NOC). The NEs operate automatically and dynamically, under non-dynamic control by the NE configuration files sent from the NOC. The NE hardware implements automated routines by which NE configuration files, including NE program, control and status memory contents, are transferred between NOC and NEs in a customized, secure fashion, while providing an abstraction for software such that the software at both the NOC computers and NEs can handle the NMS communications simply via using common standard file system and networking library functions. This is accomplished by a portal device that functions as a transparent converter between regular LAN file transfers between NOC computers and the portal, and between the customized, secured file transfer format used between the portal and NEs.

### CROSS-REFERENCE TO RELATED APPLICATIONS

The subject matter of this application is related to and makes references to the following patent applications:

[1] Co-pending U.S. utility patent application Ser. No. 10/170,260, filing date Jun. 13, 2002, by Mark Henrik Sandstrom, entitled “Input-controllable Dynamic Cross-connect”;
[2] Co-pending U.S. utility patent application Ser. No. 10/192,118, filing date Jul. 11, 2002, by Mark Henrik Sandstrom, entitled “Transparent, Look-up-free Packet Forwarding Method for Optimizing Global Network Throughput Based on Real-time Route Status”;
[3] Co-pending U.S. utility patent application Ser. No. 10/382,729, filing date Mar. 7, 2003, by Mark Henrik Sandstrom, entitled “Byte-Timeslot-Synchronous, Dynamically Switched Multi-Source-Node Data Transport Bus System”;
[4] U.S. provisional patent application, received at USPTO mail center on Sep. 30, 2005, by Mark Henrik Sandstrom, entitled “Automated, Transparent System for Remotely Configuring, Controlling and Monitoring Network Elements”,
   which are herein incorporated in their entirety by reference.
   This application further claims the benefit under 35 U.S.C. § 119(e) of U.S. provisional application U.S. provisional patent application [4].

### BACKGROUND OF THE INVENTION

1. Technical Field

The present invention pertains to the field of network management systems, in particular to automated and transparent remote management of network elements securely over third-party operated network segments.

2. Descriptions of the Related Art

Definitions of abbreviations and terms used in this specification is provided below:

ECC Embedded Communications Channel (e.g. SDH/SONET Data Communications Channel, DCC)
EMP Embedded microprocessor
FTP File Transfer Protocol; IETF RFC 959
GNE Gateway NE
GUI Graphical User IF
HDLC High-level Data Link Control, ISO/IEC 3309:1991
HW Hardware
IF Interface
IP Internet Protocol; IETF RFC 791 (IP version 4), IETF RFC 2460 (IP version 6)
LAN Local Area Network; a network whose reach is limited to its administrator's premises
NE Network element
NOC Network operations center
NMD Network management data
NMS Network management system
OS Operating system
PC Personal computer
RAM Random Access Memory
RX Receive direction, in this specification, direction of file transfer from an NE to NOC
SDH Synchronous Digital Hierarchy (an ITU-T standard for physical layer networks, includes SONET, a subset of SDH that is used in North America)
SW Software
TCP Transmission Control Protocol; IETF RCF 793
TX Transmit direction, in this specification, direction of file transfer from NOC to NE
WAN Wide Area Network; a network that reaches across domains of two or more administrators
   The globalization of communications service industries is increasing the demand for communications service providers, referred to herein as network operators, to serve their customers essentially anywhere in the world. Given the current state of global logistics services it can be economical for an operator to get a set of network devices, referred to herein as network elements (NE)s, which physically produce the customer service, shipped or installed worldwide. However, due to the high capital, labor and overhead costs and long deployment time involved with installing network capacity for extensive geographic reach, it generally is not economically feasible for any single network operator build its own physical networks to provide end-to-end connectivity between the set of NEs managed by the operator, to allow the operator to reach to all possible customer locations worldwide completely via its own networks. Therefore, for a network operator to competitively serve customers outside its own physical network reach, especially on a worldwide basis, the operator typically needs a way to manage NEs through segments of networks managed by third-party operators. Managing NEs through third-party operated networks however brings about the following problems to be addressed:
   High cost and long set-up times associated with arranging Layer 1 or 2 circuits between the operator's network operations center (NOC) and the NEs, especially when the NEs are far from the operator's own network reach;
   Lack of network security when managing NEs through a public Internet;
   The cost and complexity of implementing and managing security protocols for network management communication, which can be especially troublesome on the NEs that often are cost-sensitive and have to be based on custom hardware, due to that they often need to provide application-specific functionality, and thus no off-the-shelf security protocol software packages are available for such application-specific NEs;
   The difficulties of ensuring the required reliability, including 99.9990% of time for service availability, if NE implementation is made complicated via requiring NEs to support complex network management communication methods, such as complex Internet security protocols such as Secure Sockets Layer (SSL), Transport Layer Security (TSL), or Secure Hyper Text Transport Protocol (HTTPS). Generally, high reliability of a NE can be cost-efficiently achieved only by keeping the functional requirements for its embedded software (ESW) simple; if execution of the ESW of a NE halts, the NE needs to be re-booted to bring it back to a required operational state, and such re-booting of a NE will cause a significant service disruption. The probability of NE ESW execution halting during NE operation increases as the scope of the required functionality of the ESW is extended, due to that larger the space of possible states the NE embedded system can get to, the higher the probability will be that the NE embedded system gets to an state from which it can not recover to a regular operational state without a reboot. Reliability of a complex embedded system could in theory be improved via extensive testing, but that will increase the cost and time required to get such NEs with complex ESW deployed in the operators' managed network. In practice, with a given cost and time budget available for developing and testing NEs and their NMS communications methods, achieving good level of NE reliability and NMS communications security requires keeping their implementation simple, via an efficient architecture.
      These factors create a need for architectural innovations in the field of network management systems (NMS), particularly with NMS communications methods, that enable cost-efficient, quick-to-setup and secure management of NEs from an operator's NOC, regardless of the geographic distances of the NEs from the NOC, and even the NEs have to be managed via third-party operated i.e. multi-operator networks. Furthermore, such new NMS architecture needs to be implementable without requiring to complicate the functional requirements for NE ESW, in order to maintain the reliability and cost-efficiency of the NEs.

### BRIEF SUMMARY OF THE INVENTION

This description provides a functional specification for an NMS architecture that enables reliable, flexible and cost-efficient management of NEs from an NOC of a network operator managing the NEs, without requiring any of the NEs to be reachable from the NOC via networks administered by said network operator. The NMS architecture subject matter of this patent application provides a transparent and secure NMS communications method between general purpose computers at the NOC and the remote NEs regardless of their location. The transparent and secure NMS communications between the NOC and the remote NEs is enabled via hardware automated routines implemented by the NEs and a device called a Portal located at the NOC that functions as a transparent converter between the LAN based file transfer within the NOC and a customized, secure form of network management data (NMD) transfer between the Portal and the NEs. The invention thus provides transparent, robust and secure access by human network operators to NMD at remote NEs via user interfaces of NOC computers.

Moreover, the HW of NEs of the present invention is able to operate dynamically based on changing customer data traffic and network status conditions without requiring SW involvement, allowing the SW-HW interface of the NEs to be asynchronous, i.e., allowing NMS and NE SW to operate based on an independent timing regardless of the dynamic operation of the NE HW. Additionally, in the present invention, the NE HW also automatically performs customization of the NMS communications format to accomplish secure network management over arbitrary networks between the NOC and the NEs, while allowing the SW to be based on standard library file system and networking functions. The NMS and embedded SW for such NEs is simple and inexpensive to implement, enabling secure and reliable remote network management with cost-efficient implementation. Since the NMD of the NEs of the present invention is organized as raw binary files, which the NOC computers and NEs transfer in each direction via a set of automated routines over arbitrary LAN and WAN networks, by utilizing the principles of the present invention, the network management operations can be performed simply by managing copies of the NMD data files at NOC computers using common file management software GUIs. Such an NMS communications architecture providing transparent and automatic control and monitoring of remote devices furthermore is flexibly re-usable for managing remote devices of varying scopes of functionality used in various types of applications.

### BRIEF DESCRIPTION OF DRAWINGS

FIG. 1 presents an overview of the Network Management Systems (NMS) functional architecture that is the subject matter of the present invention.

FIG. 2 presents a functional block diagram of a Portal, a converter between PC/Unix LAN format of file transfer within a NOC, and a customized, secured file transfer between the Portal ant the remote NEs.

FIG. 3 presents a functional block diagram of a Network Element (NE) operating as a Gateway NE (GNE).

FIG. 4 presents a functional block diagram of a NE.

### DETAILED DESCRIPTION OF THE INVENTION

The invention is described herein via illustrating the novel concepts of the present invention and the operation of a preferred embodiment thereof via a detailed description of the drawings.

Symbols and notations used in the drawings:

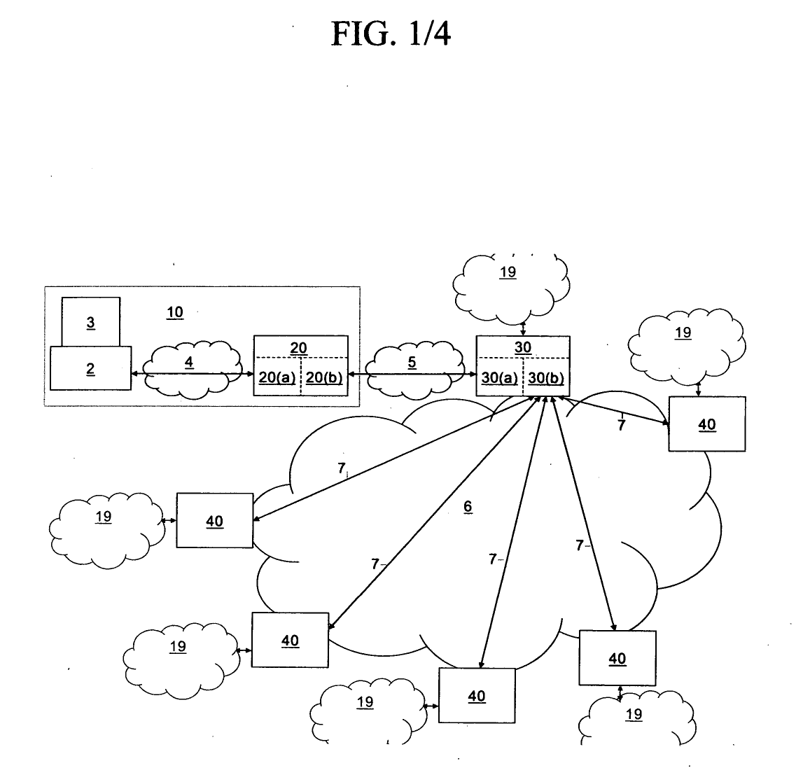

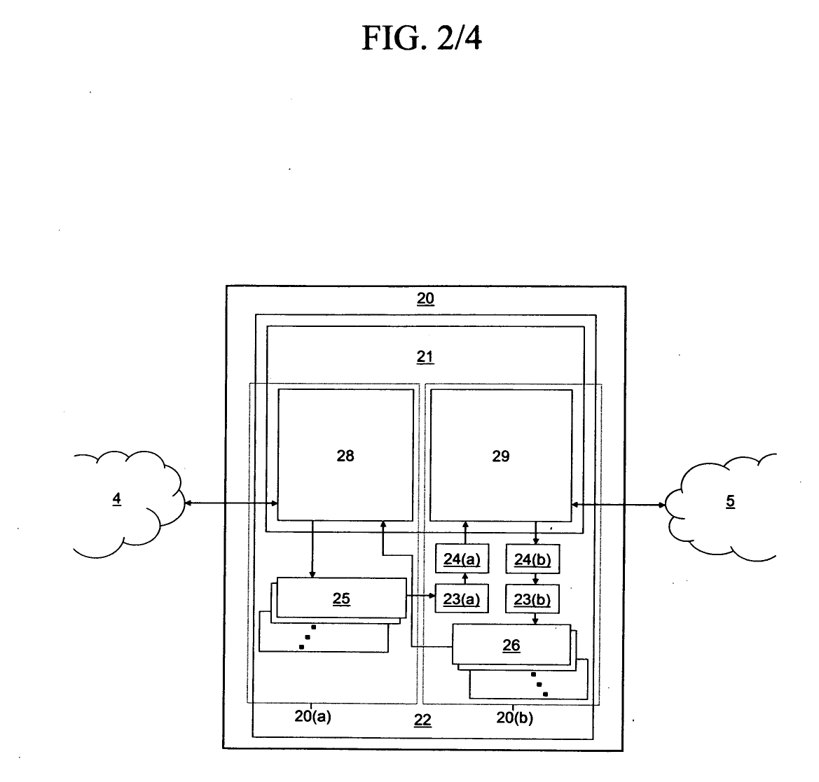

In FIG. 1 boxes represent network elements, such as routers or switches, generally referred to as network devices.
A box drawn with a dotted line indicates that the set of objects inside such a box form an object of higher abstraction level, such as, in FIG. 1, a computer 2, a LAN 4 and Portal 20 forming together a NOC 1.
Clouds represent an arbitrary network of a given class, e.g. LAN, WAN, SDH sub-network or a customer network.
Arrows between nodes in the drawings represent a logical communication path, and may consist of one or more physical wires.
Lines or arrows crossing in the drawings are decoupled unless otherwise marked.
Three dots between instances of an given object indicate an arbitrary number of instances of such an object, e.g. file buffers 25 in FIG. 2, repeated between the drawn instances.
   FIG. 1 presents a contextual overview of the NMS architecture subject matter of the present invention, comprising, at high level, of a NOC 1, a Portal 20, and a sub-network 6 being managed from the NOC 1 by a network operator. The sub-network 6 comprises at least one NE 40 operating as a GNE 30 plus a set of regular NEs 40.

In a currently envisioned embodiment, the NEs 40 produce network connectivity services, provided by the network operator managing the NEs from its NOC, to customers who need their regional networks 19 interconnected over arbitrary geographic distances. Such a service produced through NEs 40 allow a given customer's network access devices, such as personal computers and mobile phones, and their users to communicate with each other as if they were all connected via a LAN. The regional customer networks 19 can be e.g. LANs of branch offices of an enterprise, as well as they can be for instance different metro-area wireless access networks of a wireless communications service provider.

A high-level operating principle of the functional NMS architecture of this patent application is that the service that a network 6 provides is managed via a GUI 3 of a general purpose NOC computer 2 so that a human network operator, using NMS software and GUIs 3 on a NOC computer 2, has access to and manages its local copies of configuration files of NEs 40, and the NMS communications method of the present invention automatically, transparently and securely transfers such NE configuration files between the NOC 1 and the remote NEs 40, regardless of the type of networks available for NMS communications between the NOC and the NEs. Management of network service contracts provided by the network operator to its customers, including service provisioning and performance monitoring takes place via the transfer of NE configuration files between the NOC 1 and the NEs 40. Such NE configuration files in a preferred embodiment are raw binary files and include hardware and software program files for an NE, intended contents of NE control memories, and reported contents of NE status memories, and thus the operation of an NE is determined via the program and control memory sections of its configuration files. Processing of the NE configuration files, including preparation of new configuration files to be sent to NEs to affect their operation, and analyzing configuration files received from NEs to detect conditions calling for a corrective action, in a preferred embodiment takes place at general purpose computers 2. Similar to how GUIs 3 and related NMS software applications at NOC computers 2 are used to automatically manipulate and process copies of NE configuration files at the NOC computers 2, the operation of a NE 40 is controlled as a side-effect of contents of the program and control segments of its configuration files, and the copies of the status segments of NE configuration files accessed by NOC computers are reflected in the presentation of the network status via GUIs 3 at NOC computers 2. This operating principle of the NMS architecture subject matter of the invention enables managing remote NEs over arbitrary multi-operator networks, with similar simplicity as local files within the NOC computers can be accessed and manipulated using common Unix/PC type of file management SW and related GUIs.

Within the NOC 1, which in a preferred embodiment comprises a set of general purpose computers 2, a LAN 4 and a Portal 20 that provides a PC/Unix LAN compliant interface 20(a) on its NOC side, network management data (NMD) files can be transferred between the NOC computers and the Portal using standard LAN file transfer methods supported by operating systems and hardware of general purpose computers. In a preferred embodiment, within the NOC 1, the computers 2 and Portal 20 are within the same file system, enabling human network operators to access files stored at the Portal 20 as if the files were stored locally at the NOC computer that a human operator is using to perform network management functions. Furthermore, in a particular preferred embodiment, a GUI 3 of common PC/Unix file management software at NOC computer can be used to access, i.e. read and write, copies of NMD files stored at the Portal. Such NE configuration files in a preferred embodiment are raw binary files, contents of which are created and analyzed via SW and GUI 3 of computers 2, and that are automatically transferred between NOC 1 and NEs 40 via automated routines implemented by Portal 20 and NEs 40. The computers 2 and LAN 4 at NOC 1 can comprise any number of PC/Unix computers and servers 2 and Portals 20 connected via a common enterprise LAN 4, that in a currently based embodiment is based on Ethernet technology and can comprise Ethernet switch equipment. It is thus possible in certain embodiments to arrange a server 2 to operate as database server, so that human network operators that perform network management functions through GUIs 3 directly access copies of NE configuration files stored at such database server, which via an automatic routine transfers the NE configuration files between itself and Portals 20. However, even in such an embodiment utilizing a database server, the network operators effectively are to able access the NE configuration files at the Portal 20 using a GUI 3, as such database server functions as a transparent file repository between Portals 20 and GUIs 3. It is naturally possible to have more than one instance of such data base server to provide file storage and access service among NOC computers 2 with Portals 20.

Within a given sub-network 6, the NEs 40 and 30 are able transfer NMD among themselves over inter-NE management communication channels 7, which in a preferred embodiment are embedded within the network interfaces between the NEs that are used for carrying customer traffic; such inter-NE management communication channels are thus referred to as Embedded Communications Channels (ECCs) 7. In a particular preferred embodiment wherein the inter-NE network interfaces are based on SDH/SONET standards, such ECCs are made of the SDH/SONET Data Communications Channel timeslots within the SDH STM-N (N=1, 4, 16, 64, 768) frame overhead timeslots, i.e., the STM-N overhead timeslots D1, D2, D3, D4, D5, D6, D7, D8, D9, D10, D11 and D12. Subsets of these timeslots, for instance timeslots D1, D2 and D3 can be formed to enable providing a higher number of provide inter-NE channels per an STM-N frame.

While there are known standard based methods for file transfer within a NOC 1 over a LAN 4, as well as for inter-NE management communications methods within a sub-network 6 managed by the network operator managing the NEs 40 from its NOC 1, these methods do not support transferring NMD between the NOC 1 and a set of NEs 40 in a sub-network 6 when such a sub-network 6 is not reachable from the NOC 1 through networks operated by the operator that is producing the customer service with the NEs 40 of said remote subnetwork 6.

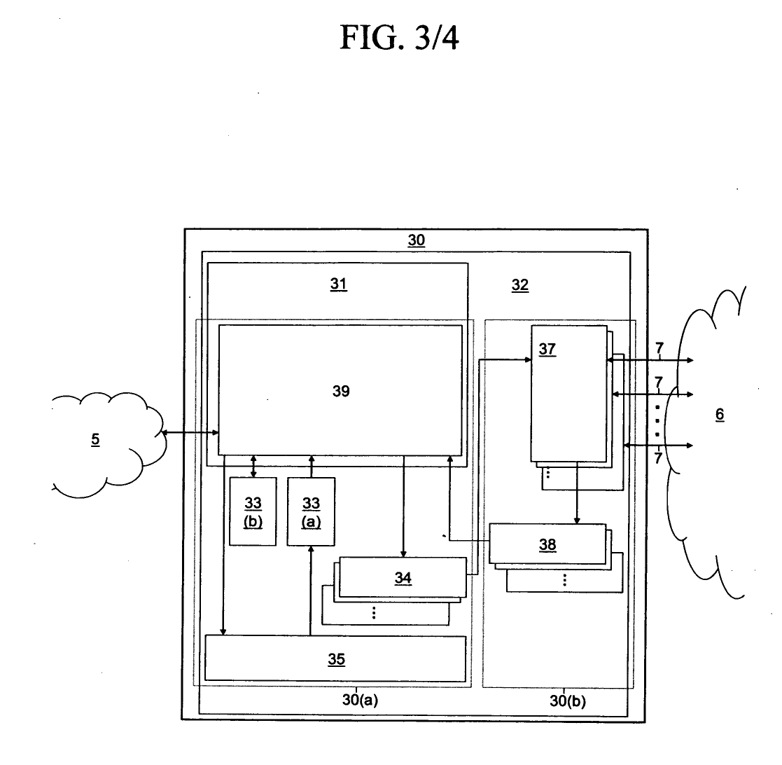

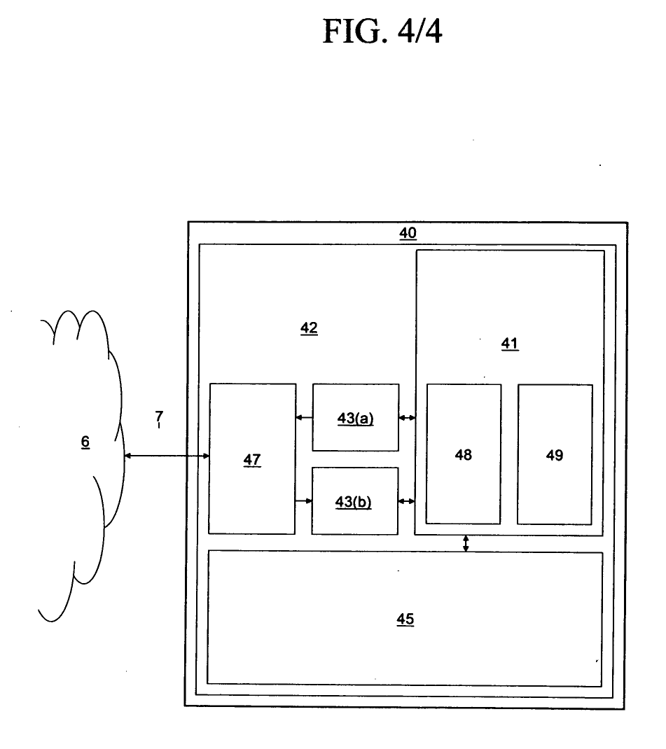

To manage NEs 40 that cannot be reached from the NOC 1 of the operator through said operator's own networks, a novel method is needed to enable secure access to NMD i.e. configuration files of such remote NEs from NOC. Such a novel method, employed between Portal 20 and a GNE 30, needs also to inter-operate with common LAN 4 file transfer methods used within the NOC 1 between general purpose computers 2 and the Portal 20, and with the inter-NE management communication methods used within sub-networks 6 managed by the operator from its NOC 1. Such a novel method is described in detail in the following in connection with discussion of the Portal, presented in FIG. 2, and NEs, presented in FIGS. 3 and 4.

FIG. 2 presents a functional block diagram of a Portal 20, divided at a high-level to its LAN IF 20(a) through which NOC computers 2 are able write and read NE configuration files stored at the Portal, and its WAN IF 20(b) through which the Portal transfers NE configuration files with NEs 40. At a more detail level, the Portal 20 comprises an EMP 21, HW logic 22 and memories 25 and 26. The HW logic 22 further comprises file encapsulation 23(a) and decapsulation 23(b) logic, and encryption 24(a) and decryption 24(b) logic.

In the transmit (TX) direction, i.e. from NOC 1 toward NEs 40, the functionality of a Portal 20 is accomplished in a preferred embodiment as follows:
1) A NOC computer 2 writes, through the LAN IF 20(a) of the Portal 20 a new NE configuration file to the Portal, to a file folder 25 associated with the target NE of the file. Since the memories 25 at Portal are within the same LAN file system as the NOC computers, a human network operator can initiate such writing of the file to the Portal for instance by copying, using a GUI 3, a file from its local folder to another folder 25 that is physically located at the Portal. At the Portal 20, such writing of a file involves standard based interaction by its file management software 28 with the file management software programs at NOC computers 2. In a particular embodiment, this file management software interaction can be implemented by an FTP server 28 at Portal 20, and an FTP client at NOC computer 2. In an alternative, simpler embodiment, TFTP can be used instead of FTP. HTTP and HTTPS can also be used to provide web based access to the files on the Portal; in such cases the SW 28 at the Portal implements an HTTP/S server. In yet another embodiment, shared file access among NOC computers 2 and Portals 3 can be implemented for instance based on Network File System (NFS). Regardless of the file system standard used within the NOC 1, writing of a file from a NOC computer 2 to a TX file folder 25 at the Portal is accomplished at the hardware level by the EMP 21, under the control by the file system software programs 28 used, receiving the new file over the LAN 4 through the LAN interface 20(a) of the Portal, and subsequently writing said file to a memory location 25 within the address space of the EMP 21 defined by destination folder designation of the file. In a currently preferred embodiment the Portal 20 provides a dedicated TX file folder 25 per each remote NE 40 the Portal is intended to serve, and such folders are implemented as memory segments in a RAM accessible by the EMP 21.
2) Once the LAN file transfer SW 28 executing on the EMP 21 of the Portal 20 has completed writing a new NE configuration file to a TX file folder 25, it signals to another SW process 29, which also includes an implementation of a file transfer protocol (e.g. FTP, TFTP), on the EMP 21 that a new file is ready for transmission to a target NE 40 associated with said folder 25. That second SW process 29 consequently reads the file from its TX folder 25, through a custom encapsulator 23(a) and a custom encryptor 24(a), and transmits the thus custom encapsulated, encrypted file through its WAN interface 20(b) toward its target NE 40. In a preferred embodiment, the encapsulation logic 23(a) inserts before the beginning of each file that is read from a TX folder 25 a set of overhead bytes that identify the length of the file, the target NE 40 of the file and the memory location within the address space of the EMP 41 of the target NE to which the file is to be written. In a particular embodiment, the first byte of the encapsulation overhead field is used to indicate a scrambling key for the file following the present file, the next two bytes the length of the file in bytes, the following four bytes the identification number of the target NE, and the final four bytes of the encapsulation overhead the beginning address of the memory segment to which the EMP 41 of the target NE 40 is to write the file. Furthermore, in a currently preferred embodiment, a defined special value, e.g. 0, in the encapsulation overhead field used to indicate the scrambling pattern for the next file, is used to signal that the file, excluding the field carrying said special value which itself is not scrambled, is scrambled using a default scrambling pattern i.e. the scrambling pattern used for the initial file transmission following the boot-up of a Portal or a NE. Additionally, in a preferred embodiment the encapsulation logic appends a checksum field to the end of the file so that the target NE can detect the integrity of the file once it receives it. In a particular embodiment providing a simple implementation, the checksum used is a byte-wide bit-interleaved-parity (BIP-8). Following the encapsulation, in a preferred embodiment the entire encapsulated file is encrypted using an implementation-efficient scrambling mechanism, which however is frequently updated via providing new scrambling keys via the encapsulation protocol. In a simple implementation of such a scrambling based encryptor, the encryptor will do a bit-by-bit exclusive—or function between the scrambling key used and each byte of the file, including the encapsulation overhead in a preferred embodiment. Regardless of the specific implementation of the custom encapsulation and encryption methods in a given embodiment, the standard file transfer SW 29 treats such custom encapsulated, encrypted files as plain binary payload files that it reads from TX folder 25 and sends over the WAN port 20(b) toward the target NE of such NE configuration file. In a preferred embodiment, a given group of TX folders 25 at a Portal is associated with a particular sub-network 6, and the Portal 20 communicates with NEs 40 within a given sub-network normally through one of the NEs within the subnetwork designated as a Gateway NE (GNE) 30 of the subnetwork 6. Thus, in case the Portal and a given GNE 30 need to communicate over Internet, the Portal automatically knows the destination IP address for the IP packets used for carrying the NE configuration files from a given group of TX folders 25 to their target subnetwork 6, as each folder group is directly mapped to a destination IP address of the GNE of the subnetwork associated with the given group. At a SW level of abstraction, the groups of TX folders 25 can be presented as upper level folders holding TX folders for NEs of the subnetwork 6 associated with such upper level folders. At the HW level, such groups of TX folders 25 are different memory segments within the address space of the EMP 21 of the Portal 20.

In the receive (RX) direction, i.e. from NEs 40 toward NOC 1, the functionality of a Portal 20 is accomplished in a preferred embodiment as follows:
1) The WAN side 5 file transfer SW program 29 of a Portal 20 receives a NE configuration file via its WAN interface 20(b), and subsequently writes it to a RX file buffer, which in a preferred embodiment is implemented within the HW logic 22. The decryption logic 24(b) of Portal HW reads the file from the RX file buffer, decrypting the file, in a preferred embodiment by scrambling it using the scrambling key provided via the previous file received from the given source NE. Following decryption, file decapsulation logic 23(b) then writes the file to an RX folder 26 associated with the source NE 40 of the file, which NE the decapsulation logic 23(b) identifies via processing encapsulation overhead of the file.
2) Similar to TX folders 25, the decrypted and de-capsulated NE configuration files in the RX folders 26 are accessible to the NOC computers 2 using standard LAN file access methods (e.g. FTP, TFTP, NFS, HTTP) supported by the LAN side 4 file management software 28 of the Portal 20. In a particular embodiment, the NOC computers 20 include a file database server, to which the LAN side SW process 28 automatically sends received files from its RX folders 26 when signaled by the WAN-side SW process 29 that a new NE configuration file received from a remote NE 40 has been written to its associated RX folder 26.
   On both its LAN interface 20(a) and WAN interface 20(b), the embedded SW (ESW) of Portal 20 uses standard networking library functions supported by the embedded OS for the EMP 21. In a preferred embodiment, these networking functions are based on the TCP/IP suite, and Ethernet is used as the physical layer of the LAN and WAN interfaces. This embedded system architecture for Portal 20 eliminates the need to develop custom file transfer SW protocols to accomplish the transparent conversions between the file transfer method in LAN 4 supported by general purpose computers 20, and the custom form of secured file transfer on the WAN side 5. It is observed from the above discussion that in both TX and RX directions the scope of functionality of the ESW application programs at Portal is effectively limited to file transfer using standard networking library functions, and to writing and reading files to and from its local memories 25, 26 using file system library functions.
   FIG. 3 presents a functional block diagram of a NE operating as a Gateway NE (GNE) 30, whose NMS related functionality is divided at a high-level to its WAN side management IF 30(a) and its set of ECC IFs (30b). Though NEs, including GNE, have also additional functionality including connection of customer data traffic between its set of network interfaces, to clarify the drawings only the NMS related functionality of NEs is included in FIGS. 3 and 4, due to that the present invention is related to the NMS aspects of the NEs. As hardware units, NEs 40 including GNEs 30 in a preferred embodiment are closely similar to the Portal unit 20 described above in connection with FIG. 1, with a main difference between Portals and NEs typically being that NEs need to support, in addition to the NMS communications interfaces, also network interfaces for carrying customer traffic originating from or destined to customer networks 19.

In the transmit (TX) direction, i.e. from NOC 1 toward target NEs 40, the functionality of a GNE 30 is accomplished in a preferred embodiment as follows:
1) A file transfer protocol software process 39 executing on an EMP 31 of the GNE 30 receives a NE configuration file over a WAN 5 from the NOC 1 through the management IF 30(a) of the GNE 30, and subsequently writes the file, i.e. the payload of a file transfer protocol, to a TX file folder 34 identified by the file transfer protocol (e.g. FTP, TFTP) used between the Portal 20 and the GNE 30. At the HW level, such TX file folders 34 are segments of RAM within the address space of the EMP 31. In a preferred embodiment, IX file folders 34 are implemented as RAM using device registers within the HW logic 32 of the GNE 30. If the destination folder of the file, identified by the file management SW process 39 based on the file transfer method used corresponds to the local NE configuration file memories 35 of the GNE 30, the EMP 31, under control by the file management SW 39, writes the file through HW decryption and decapsulation logic 33(b) to a file buffer from where the EMP 31 copies the decrypted, decapsulated NE configuration file to the destination folder 35 identified via the file transfer protocol with which the file was sent from a Portal 20 to the GNE 30. The decapsulation protocol logic 33(b) further tests the integrity of NE configuration file, including by testing whether its checksum is valid, before enabling writing of such file to the local NE configuration file memory 35 of the GNE.
2) Files that, based on the destination folder indicated via the file transfer method used between a Portal 20 and a GNE 30, are written by the file management software 39 to TX file folders 34 associated with NEs 40 other than the local GNE 30, are automatically sent by an ECC mapper 37 associated with the ECC channel 7 to the target NE 40 corresponding to the TX folder 34 to which the file was written by SW process 39. Since in a preferred embodiment both the TX folders 34 and ECC mapper 37 are implemented within the HW logic 32, the HW logic is able to automatically detect when a new file has been written to a TX folder 34, and consequently send such a file to its target NE 40 over the ECC 7 associated with said target NE, identified by ECC mapper 37 based on the segment of RAM 34 forming the TX file folder 34 associated with that target NE 40. At a more detail level, in TX direction, the ECC mapper module 37 accomplishes its function of mapping a file from its associated TX folder 34 to its associated ECC 7 by first inserting a special byte pattern, i.e. a flag, in front of the new file to signal to the target NE 40 a beginning of a new frame on ECC 7, and following that maps the bytes of the file to the timeslots assigned for its ECC, masking bytes of file equal to the flag to mark them as payload bytes instead of file boundary flags. In a particular embodiment, such framing of files for transmission over an ECC, i.e., flagging of frame boundaries and masking of bytes equal to the flag within files is done according to the HDLC forming mechanism.

In the receive (RX) direction, i.e. from a source NE 40 toward the NOC 1, the functionality of a GNE 30 is accomplished in a preferred embodiment as follows:
1) The ECC mapper 37 receives a NE configuration file from a source NE 40 over an ECC 7 associated with said NE 40 and writes the file to an RX file folder 38 associated with said ECC 7.
2) The received files stored at RX file folder 38 are read by the file transfer SW process 39 executing on the EMP 31 of the GNE 30 as payloads of the file transfer protocol (e.g. FTP, TFTP) used to carry files over WAN 5 between the GNE 30 and its associated Portal 20. In a particular embodiment providing a simple implementation, the file management SW 39 periodically, in a round-robin fashion, sends the files from its RX folders 38 as well as from its local memories 35 over the WAN 5 to the Portal 20. In a preferred embodiment, the NOC 1 however can instruct for a GNE 30, via configuring related device control registers within memories 35 of the GNE, which files within the memory space of the EMP 31 including folders 38 the GNE shall send to the NOC 1 next, to allow the NOC 1 to get the status of a particular NE 40 or GNE 3Q of concern in an expedited fashion. Files from the local memories 35 of the GNE 30 are encapsulated and encrypted by logic 33(a) the same way the encapsulator 23(a) and encryptor 24(a) at the Portal 20 do. GNE 30 sends files to the Portal 20 over the WAN 5 in a way similarly to how Portal sends files to GNE described in connection with FIG. 2, i.e., in a preferred embodiment it uses standard TCP/IP over Ethernet networking functions networking supported by the OS of the GNE. Also, in a preferred embodiment, a given GNE has a primary Portal associated with so it knows the destination IP address for IP packets used for carrying the NE configuration files from the GNE to the NOC.
   It is observed from the above discussion that in both TX and RX directions the scope of functionality of the ESW application programs at GNE is effectively limited to receiving and sending files, using networking library functions commonly supported by embedded OSs, and to writing and reading files, also using standard library functions, to and from its local memories, including TX file folder 34, RX file folder 38 and local NE configuration file memory 35.
   FIG. 4 presents a functional block diagram of a regular NE 40, i.e., a NE that is not operating as a GNE 30. In a preferred embodiment, regular NEs are capable of operating also as GNEs, i.e. they have a WAN/LAN IF similar to the WAN/LAN management IF 30(a) of NE operating as a GNE. The NE configuration files at memories 45 define whether a given NE 40 shall operate in a GNE mode or in a regular NE mode. In such a preferred embodiment, the physical HW of a NE is thus similar whether it is operating as GNE 30 or a regular NE 40. When operating in a regular NE mode, the NE 40 transfers its NE configuration files with the NOC 1 via an ECC 7 and through a GNE 30, instead of directly over a WAN 5 as a NE operating in a GNE mode does. Therefore, the NMS functionality of a regular NE is effectively a subset of the functionality of a GNE.

While a NE normally, in addition to the NMS communications discussed herein, provides functionality to connect customer data traffic between its network interfaces, such a customer traffic related functionality is not an integral part of this specification as the present innovation applies to a novel NMS architecture for managing NEs 40. However, in a currently envisioned embodiment, the NEs, including GNEs, provide network connectivity service between geographically dispersed customer networks 19, and in a particular preferred embodiment, employ inventions of referenced applications [1], [2] and [3] to provide such network connectivity services using a self-operating network data-plane i.e. intelligent NE HW 42 to allow dynamic network operation even with static NMD i.e. static NE configuration files for the duration of a given network service contract. Such self-optimizing, self-conguring network hardware allows an asynchronous HW-SW interface at NEs 40, including GNEs 30 and Portal 20, which in turn allows the SW of such NEs to execute based on its own timing regardless of the dynamics of data plane events, such as a signal failure requiring protection re-routing of certain customer traffic flows.

The functionality of the NE 40 related to NMS communications, which the present invention concerns, is accomplished in a preferred embodiment in the TX direction, i.e. from a NOC 1 toward a NE 40, as follows:
1) The ECC mapper 47 of the NE 40 receives a framed file from a GNE 30 over an ECC 7, removes the framing and provides the file to a custom decryptor and decapsulator logic module 43(b). According to the discussion in connection with FIG. 3, in a particular embodiment, file framing per HDLC protocol is used for indicating the file boundaries as they are transmitted over ECCs. The decryptor of module 43(b) provides an inverse function of the encryptor 24(a) that encrypted the file at the Portal 20, and in case of the simple scrambling based encryption described in connection with FIG. 2, the decryptor normally simply performs an exclusive—or logic function between each byte of the file and the scrambling pattern provided via a previous file received from the Portal. Following the decryption, encapsulation overhead is processed and the NE configuration file is decapsulated by module 43(b). This involves the same functions as the module 33(b) performs at the GNE for its local NE configuration files that it stores at its local memories 35, which functions are described in connection with FIG. 3.
2) A file management SW process 48 at the EMP 41 of the NE 40 writes the decrypted, decapsulated NE configuration file to its intended memory location 45 within the address space of the EMP 41 of the NE 40. In a preferred embodiment, the decapsulator of module 43(b) provides the start address of the memory segment within the address space of the EMP 41, to which the decapsulated file is to be written by EMP 41, for read by the file management SW 48 executing on the EMP. As per the description in connection with FIG. 2, in a particular embodiment, the intended location of the file within the address space of the EMP 41 of the target NE 40 is communicated from the Portal 20 to the target NE 40 via a 4-byte field within the custom encapsulation protocol overhead of the file, and the module 43(b) provides this 32-bit address for the SW process 48, which accordingly copies the decapsulated NE configuration file from a RAM buffer at module 43(b), which also is memory-mapped to the address space of the EMP 41, to the intended final address of the file within the local memories 45 of the NE.

In the RX direction, i.e. from a NE 40 toward the NOC 1, the NMS related functionality of a NE 40 is accomplished in a preferred embodiment as follows:
1) The file management SW 48 executing on the NE 40, via a periodic routine, copies its NE configuration files from its memories 45 storing its NE configuration files to a file buffer, also memory-mapped to the address space of the EMP 41, within a HW logic module 43(a) that performs custom encapsulation and encryption for the file, in a way similar to encapsulator 23(a) and encryptor 24(a) at a Portal 20 do. In a preferred embodiment however the encapsulator 43(a) at a source NE 40 or GNE 30 also inserts a timestamp to the custom encapsulation overhead to indicate to the NOC 1 the time when the file was sent to it from its source NE. In a particular, implementationally simple embodiment, such file timestamp is the count of seconds since the NE boot-up, i.e., the value of an overruning 32-bit second-counter at the NE at the time the file is encapsulated. Certain embodiments also include file identification serial number in the encapsulation overhead. These additional encapsulation overhead fields can also be included for files sent from a Portal 20 to target NEs 40. Furthermore, in a preferred embodiment, to ensure timely reporting of NE status to the NOC, the SW 48 operates so that the status memory segments, i.e., device status register contents, of the NE configuration files 45 are send to the NOC 1, over the ECC 7, with a defined minimum frequency, while the rest of the NE configuration files 45, i.e., device control registers contents and NE program memories are sent to the NOC as a lower priority background process.
2) The ECC mapper 47 frames the custom encapsulated, encrypted NE configuration files, and transmits such framed files via an ECC 7 to the GNE 30 of the subnetwork 6 to which the source NE 40 belongs to. This framing and ECC mapping by ECC mapper 47 of a regular NE 40 works in a way similar to the ECC mapper 37 of GNE 30.

Finally, a SW process 49 at NEs 40, including GNEs 30, periodically, e.g. in every 10 seconds, monitors a set of reboot device control registers at a defined address within the NE configuration file memories 45, and if the contents of the reboot control registers instructs the NE to reboot, the SW 39 looks up, also via the reboot control registers, an addresses of the new NE program files within the memories 45 with which to boot-up the NE the next time, and subsequently calls for the NE to reboot with said new boot-up files. Note that, besides the boot-up files, the reboot device control registers of the NE itself is writable from a NOC 1 via sending new NE configuration files to the NE 40. The reboot device register can be remotely, from the NOC, reconfigured by sending to the NE a configuration file containing the intended new value of the NE reboot control registers, including the new value of an NE reboot instruction register and the registers indicating the addresses of the new boot-up files. Naturally, the boot-up files need to ensure that the NE boots up always with its reboot instruction register configured in its passive value.

Per discussion in the foregoing regarding FIGS. 2, 3 an 4, the required scope of functionality of the ESW application programs at NEs 40, including GNEs 30 and Portals 20, is effectively limited to receiving and sending files, using standard networking library functions commonly provided by OSs for embedded systems, and to writing and reading files, also using standard library functions, to and from the local memories of NEs. This significantly simplifies the implementation of the embedded software for these devices of Portal, GNE and NE, reducing their development and testing time and cost, and improving their reliability and upgradeability. In a preferred embodiment where also the HW logic 22, 32 and 42 of these devices is in-system programmable and remotely upgradeable, the simplicity of the ESW and the asynchronous SW-HW interface of the devices Portal, GNE and NE enables flexible reuse of the physical HW and embedded SW of devices 20, 30 and 40, discussed above for multiple types of device functionality for different applications, based on different HW logic configurations of said devices. In a currently preferred embodiment, the HW logic functionality of a device 20, 30 or 40 is defined via the hardware logic program file included in the NE configuration files with which said device boots up with. The NMS functional architecture of this patent application therefore can be used for remotely managing, including configuring, controlling and monitoring, devices of unlimited functionality within a scope defined by the physical hardware of a given device.

### Description of Preferred Embodiment

The subject matter of the present invention is a secure and flexible, yet implementationally simple, and thus robust and reliable NMS architecture for managing a set of remote NEs from a NOC of the network operator. An overview of such NMS architecture is shown in FIG. 1, and its building blocks, namely NMS Portal 20, Gateway NE 30 and a regular NE 40 are described above in connection with FIGS. 2, 3 and 4. The NMS architecture of the present invention allows to securely and reliably configure, control and monitor NEs even in cases where some or all of the NEs are not reachable from the NOC via networks administered by the operator providing network services through said NEs for its customers. In such cases, the remote NEs typically have to be managed through networks administered by third-party network operators, and a common scenario is that the NMS communication between the NOC and remote NEs is routed though the public Internet. The reasons for this include the cost and delays associated with setting up dedicate Layer 1 or 2 circuits across other operators' networks between the NOC and the NEs. It is however possible to utilize the NMS architecture of the present invention also in circumstances where the NEs being managed can be reached from the NOC via the operator's own networks, without requiring a change to the NMS implementation. As such, the scope of viable applications for the NMS architecture of this patent application is more extensive than that of conventional NMSs that typically require the operator of the network to be in control of the network all the way from the NOC to each NE for secure network management.

Per descriptions of the drawings in the foregoing, the key features of the invention include:
1) NE embedded system architecture that enables NEs of a sub-network to operate in the same secure file system, without requiring NE ESW applications to do essentially anything else than copy files between different memory locations within their own address space. The main benefits of such an embedded system architecture include improved reliability, upgradeability and cost-efficiency of the NEs.
2) Secure network management communication method between NOC and NEs over a third-party operated network, using common Internet based file transfer protocols (e.g. FTP, TFTP) commonly supported by operating systems for both embedded processors and general purpose computers. The main benefits of this method include high-level of network management communications security achieved with simple ESW implementation, improving the reliability and cost-efficiency of implementation of Portals and GNEs.
3) NMS functional architecture that allows human network operators to securely access the configuration files of remote NEs via a GUI of NOC computers, as if the NE configuration files were local files at the NOC computers, even when some of the NEs cannot be reached via networks administered by the operator managing said NEs i.e. when NEs have to be managed at least in part through a network managed by another operator. The benefits of such an NMS architecture includes simplicity and cost-efficiency of implementation and administration through the use of common standard PC/Unix LAN file systems and file management software supported by OSs of general purpose computers, and transparent access to NE control and status data, regardless of the distances of NEs from the NOC.

Correspondingly, the key implementation principles of the present invention enabling the above features and benefits are:
1) Intelligent NE HW, e.g. network hardware utilizing inventions of the referenced patent applications, [1], [2] and [3], that is able to perform all response-time critical actions at network data and control plane levels, under static SW control i.e. without need for dynamic SW involvement. Furthermore, in a preferred embodiment, per FIGS. 2, 3 and 4, all custom processing related to transfer of NMD files between NOC and NEs, i.e. protocol processing such that that is not supported by standard networking libraries, is done automatically by HW logic of Portal and NEs without a need for SW to be even aware of such HW logic processing. In such a preferred embodiment, this HW logic processing includes custom encapsulation and encryption of payloads of standard file transfer protocols, to allow the HW of Portal and NEs to implementation-efficiently and securely route and transmit NE configuration files between folders at the Portal and the source/target NEs.
2) The use of standard networking library SW functions supported by both general purpose computer and embedded OSs for file transfer between Portals and GNEs reduces the cost and time required to develop and test the customized, secured network management communications method between NOC and NEs. Moreover, such library functions for networking and file management are generally well tested to work reliably in a wide range of application as they are widely used, and the use of such library functions significantly simplifies the scope of functionality required to be implemented by custom-designed ESW applications. In a preferred embodiment of Portal and NEs, per FIGS. 2, 3 and 4, the scope of required functionality of ESW is reduced to simply file transfer using standard networking library functions and copying files between memory locations within the local address space of the EMP of a given device of either Portal 20, GNE 30 or NE 40.
3) Architectural division between the common standard Unix/PC LAN and file systems used within the NOC, and the custom, secured file transfer methods used between the NOC and the NEs, enabled by a Portal device that supports Unix/PC LAN networking and file systems on its LAN interface with NOC, and customized file transfer methods used on its WAN interface with NEs. Furthermore, that the Portal and NE HW logic implement automatic routines by which new NE control data files are automatically transferred from LAN-accessible memories at Portal to their remote target NEs, and NE status data files are automatically and periodically collected from the remote NEs to LAN-accessible memories at Portal, provides for the NOC effectively a direct and transparent access to NE configuration files, using common LAN file systems, even when some of the NEs are not reachable from the NOC via networks of the network operator managing said NEs.

Therefore, the present invention cost-effectively provides means for securely managing communications services networks from a NOC of the network operator using general purpose computers and common PC/Unix file management software with user-friendly GUIs, regardless of the location of the NEs of the communications service networks being managed. Furthermore, when utilizing principles of the present invention, and in particular when combining the NMS architecture of the present inventions with the principles of self-operating, self-optimizing network data plane provided in referenced patent applications [1], [2] and [3], the implementation of the embedded SW of the NEs is significantly simplified from conventional implementations, which, unlike the NE ESW per this specification, normally require response time critical interaction between NE HW and SW for the network to be operational, and require significantly more complicated functionality of ESW applications than the standard networking and file system library functions with which the NE ESW per the present invention is able to accomplish the NMS communications functions. The simplicity of the NE ESW is critical to the quality and reliability of the services produced to customers of the network operator, since the NEs physically produce the service of the network to the customers, and therefore ESW of the NE generally is not allowed to get caught in a state that renders the NE as wholly or partly non-functioning. For any given budget available for the development and testing of the NEs and the network services, the simpler the implementation of the embedded SW that allows to accomplish the required functionality of the NE, the higher the reliability of the NEs and the better the quality of the service produced by a network based on such NEs.

The referenced related provisional application [4] provides application oriented system engineering specifications for of an embodiment of the NMS architecture according to principles of the present invention, to provide an example of a practical use of the principles of the present invention for managing remote NEs through multi-operator networks i.e. through networks with segments administered by a third-party operator.

Conclusions

This detailed description is a specification of a currently preferred embodiment of the present invention. Specific architectural and logic implementation examples are provided in this and the referenced patent applications for the purpose of illustrating a currently preferred practical implementation of the invented concept. Naturally, there are multiple alternative ways to implement or utilize, in whole or in part, the principles of the invention as set forth in the foregoing.

For instance, while the presentation of the NMS architecture subject matter of the present patent application, overview of which is shown in FIG. 1, is reduced to illustrating the organization its basic elements, it shall be understood that various implementations of that architecture can have any number of NEs served by a GNE, any number of GNEs served by a Portal, and any number of Portals per an NOC. Moreover, there can be several GNEs per a sub-network, several sub-networks managed from a NOC, and several NOCs per a network operator, more than one of which can be capable of managing a given sub-network. Furthermore, the Portals, GNEs and regular NEs can have several EMPs and several LAN/WAN management interfaces each. Also, in different embodiments of the invention, the sequence of software and hardware and logic processes involved with NMS communications can be changed from the specific sequence described, the process steps could be combined with others and further divided in to sub-steps. Furthermore, the elements of the NMS architecture, i.e. NOC computers, Portals, GNEs and NEs, described in this specification for clarity as separate devices can in different embodiments of the invention be combined with other devices or further subdivided in to additional device without departing from the principles of the present invention. It is also obvious to those skilled in implementing embedded systems how certain functions, e.g. the custom encapsulation and encryption, which in the preferred embodiment described in the foregoing as being implemented by HW logic, could in an alternative implementation of the principles of the invention be performed by SW programs.

Therefore, those skilled in the art will be able to develop different versions and various modifications of the described embodiments, which, although not necessarily each explicitly described herein individually, utilize the principles of the present invention, and are thus included within its spirit and scope. It is thus intended that the specification and examples be considered not in a restrictive sense, but as exemplary only, with a true scope of the invention being indicated by the following claims.

What is claimed is:

1. A network management system, comprising:
a network operations center (NOC) of a network operator,
a set of network elements (NEs) managed by the network operator,
a network device, referred to herein as a Portal, through which the NOC and the NEs transfer NE configuration files,
wherein:
the NOC comprises a set of general purpose computers used by human network operators for managing the NEs via transferring NE configuration files to and from the NEs,
the NOC and the Portal are connected over a local area network enabling the NOC to access copies of NE configuration files stored at the Portal using common file management software as if said NE configuration files were local files on the NOC computers, and
the Portal and the set of NEs transfer NE configuration files between themselves via a set of automated routines, allowing the NOC to manage the set of NEs in a way similar to how the NOC is able to manage local files on the NOC computers, without requiring any of the NEs among said set to be reachable to the NOC via networks administered by the network operator managing said set of NEs.

2. The network management system according to claim 1, wherein the NE configuration files for a given NE within said set includes any subset, including all, of:
a set of hardware logic program files,
a set of software programs,
contents of device control registers, and
contents of device status register.

3. The network management system according to claim 1, wherein the set of general purpose computers that belong to the NOC includes at least one server computer through which other NOC computers are able to access copies of NE configuration files stored at the Portal.

4. The network management system according to claim 1, wherein the Portal and the set of NEs transfer NE configuration files using a standard file transfer protocol commonly supported by operations systems of general purpose computers and embedded systems, and common standard networking protocols at least for ISO OSI protocol layers 1, 2, 3 and 4.

5. The network management system according to claim 4, wherein the set of automated routines via which the Portal and the set of NEs transfer NE configuration files between themselves includes encapsulation and encryption of the files for transmission between the Portal and a given NE among said set of NEs.

6. The network management system according to claim 5, wherein the encapsulation is accomplished by a custom encapsulation protocol not intended to be supported by devices other than the Portal and the NEs managed by the network operator.

7. The network management system according to claim 5, wherein the encryption is accomplished by a custom encryption protocol not intended to be supported by devices other than the Portal and the NEs managed by the network operator.

8. The network management system according to claim 6, wherein the custom encapsulation protocol provides means for indicating for an encapsulated file any subset, including all, of:
a source NE of the file,
a destination NE of the file,
a length of the file,
an identification number of the file,
a transmission time stamp, and
a checksum.

9. The network management system according to claim 6, wherein the encryption is applied for the files including all fields of the custom encapsulation protocol.

10. A method for transferring Network Management Data (NMD) between a network operations center (NOC) and a set of network elements (NEs), at least one of which is operating as a Gateway NE (GNE), through a device referred to herein as a Portal and over a wide-area-network (WAN), the NEs having interfaces that are used at least in part for customer traffic and for transferring NMD, the Portal having an interface for transferring NMD with GNEs and an interface for transferring NMD with general purpose computers at the NOC over a local-area-network (LAN) based on a common standard LAN file system, the WAN being based on industry standard networking protocols at least for ISO OSI protocol layers 1, 2, 3 and 4, the NMD being organized as binary files, the method comprising:
transferring NMD files, by and between the Portal and a GNE, as payloads of a common standard file transfer protocol, and
processing, by the Portal and a GNE, said payloads using a set of custom protocols that are not intended to be supported by devices other than the Portal and the set of NEs.

11. The method of claim 10, wherein each NE of the set of NEs is capable of operating as a GNE.

12. The method of claim 10, wherein each NE of the set of NEs is operating as a GNE.

13. The method of claim 10, wherein the standard file transfer protocol used between the Portal and the GNE is Trivial File Transfer Protocol.

14. The method of claim 10, wherein the standard file transfer protocol used between the Portal and the GNE is File Transfer Protocol.

15. The method of claim 10, wherein the set of custom protocols by which the Portal and the NE process the payloads of the standard file transfer protocol used include custom protocols for encapsulation and encryption.

16. The method of claim 15, wherein the custom encapsulation protocol provides means for indicating for the NMD file any subset, including all, of:
a source network device of the file,
a destination network device of the file,
a length of the file,
an identification number of the file,
a transmission time stamp, and
a checksum.

17. A method for automatically transferring contents of memories among a set of network elements (NEs) by a set of automated routines implemented by hardware logic of the NEs, allowing an NE to read and write contents of memories of another NE within said set by reading and writing its local memories.

18. The method according to claim 17, wherein the memory contents are files, allowing an NE to access files at memories of another NE of the set in a way similar to how the NE is able to access files in its local memories.

19. The method according to claim 18, wherein the NEs have channelizable network interfaces that provide embedded communications channels (ECCs) for transfer of files between the NEs.

20. The method according to claim 19, wherein the NEs have SDH/SONET network interfaces and the ECCs are made of SDH/SONET overhead timeslots usable for network management communications.

21. The method according to claim 20, wherein the ECCs are made of SDH/SONET overhead Data Communications Channel timeslots D1, D2, D3, D4, D5, D6, D7, D8, D9, D10, D11 and D12, including any subset of said timeslots.

22. The method according to claim 19, wherein the set of automated routines by which NEs of said set transfer files among themselves comprises routines for sending and receiving files through ECCs from a sending NE to a receiving NE.

23. The method according to claim 22, wherein the routine of sending a file through an ECC, carried out by the hardware logic of the sending NE, further comprises sub-steps of:
reading file data from a software-writable memory location called a file buffer,
processing the file for transmission over the ECC, and
mapping of the file data from its file buffer to the ECC.

24. The method according to claim 23, wherein the step of processing a file for transmission over an ECC comprises a sub-step of encapsulating the file.

25. The method according to claim 23, wherein the step of processing a file for transmission over an ECC comprises a sub-step of encapsulating the file as a payload of an encapsulation protocol, wherein the encapsulation protocol provides means for indicating for the file transmitted on the ECC any subset, including all, of:
a beginning of the file,
an end of the file,
a source NE of the file,
a destination NE of the file,
a length of the file,
an identification number of the file,
a transmission time stamp of the file, and
a checksum.

26. The method according to claim 23, wherein the step of processing a file for transmission over an ECC comprises a sub-step of encrypting the file.

27. The method according to claim 23, wherein the step of processing a file for transmission over an ECC comprises sub-steps of encapsulating and encrypting the file.

28. The method according to claim 27, wherein the sub-step of encrypting is applied for the file including its encapsulation overhead fields.

29. The method according to claim 22, wherein the routine of receiving a file through ECC, carried out by the hardware logic of the receiving NE, further comprises sub-steps of:
processing a file received over the ECC, and
writing the received and processed file to a software-readable memory location.
